(19) United States
(12) Patent Application Publication
(10) Pub. No.: US 2024/0124357 A1
(43) Pub. Date: Apr. 18, 2024

(54) Gypsum Panel Containing a Chloride Ion Mitigating Additive

(71) Applicant: Gold Bond Building Products, LLC, Charlotte, NC (US)

(72) Inventors: R. G. Iyer, Fort Mill, SC (US); Bradley J. Busche, Shelby, NC (US); Eli Stav, Charlotte, NC (US); Joseph J. Bailey, Charlotte, NC (US); Brian Bland, Charlotte, NC (US); Rick Atkisson, Charlotte, NC (US)

(21) Appl. No.: 18/486,286

(22) Filed: Oct. 13, 2023

Related U.S. Application Data
(60) Provisional application No. 63/415,846, filed on Oct. 13, 2022.

(51) Int. Cl. C04B 28/14; C04B 14/10; C04B 14/16; C04B 14/18; C04B 18/10

(52) U.S. Cl. CPC C04B 28/14; C04B 14/102; C04B 14/16; C04B 14/18; C04B 18/10; C04B 2111/0062

(57) ABSTRACT

The present invention is directed to a gypsum panel and a method of making such gypsum panel. For instance, in one embodiment, the gypsum panel comprises a gypsum core and a first facing material and a second facing material sandwiching the gypsum core, wherein the gypsum core includes gypsum and one or more chloride ion mitigating additives. The methods of the present invention are directed to making the aforementioned gypsum panels by providing the first facing material, providing a gypsum slurry comprising gypsum, water, and the respective additive onto the first facing material, and providing a second facing material on the gypsum slurry.

### RELATED APPLICATIONS

The present application is based on and claims priority to U.S. Provisional Patent Application Ser. No. 63/415,846, having a filing date of Oct. 13, 2022, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum, water, and other conventional additives. The mixture is cast and allowed to set by reaction of the calcined gypsum with the water. During the production process, the gypsum slurry and/or the gypsum core may contain a high chloride concentration. High concentrations of chloride ions can result in various negative effects including inadequate drying of the gypsum core, poor facing material-core bond, and increased calcination. Historically, to combat high chloride concentrations in gypsum panels, companies have mined gypsum locations known for low chloride content, washed gypsum to reduce chloride concentration, and/or utilized reverse osmosis systems to process water with high chloride concentrations. However, these methods are notably time intensive and cost intensive.

As a result, there is a need to provide an improved gypsum panel that provides for chloride ion mitigation.

### SUMMARY OF THE INVENTION

In accordance with one embodiment of the present invention, a gypsum panel is disclosed. The gypsum panel comprises a gypsum core and a first facing material and a second facing material sandwiching the gypsum core, wherein the gypsum core comprises gypsum and one or more chloride ion mitigating additives comprising volcanic rock, amorphous volcanic glass, pyrolyzed biomass, a silicate, or a combination thereof, the one or more chloride ion mitigating additives reducing the chloride ion content of the gypsum panel by about 10% or more.

In accordance with another embodiment of the present invention, a method of making a gypsum panel is disclosed. The method comprises: providing a first facing material; depositing a gypsum slurry comprising stucco, water, and one or more chloride ion mitigating additives onto the first facing material, wherein the one or more chloride ion mitigating additives comprise volcanic rock, amorphous volcanic glass, pyrolyzed biomass, a silicate, or a combination thereof, the one or more chloride ion mitigating additives reducing the chloride ion content of the gypsum panel by about 10% or more; providing a second facing material on the gypsum slurry; and allowing the stucco to convert to calcium sulfate dihydrate.

In accordance with one embodiment of the present invention, a gypsum panel is disclosed. The gypsum panel comprises a gypsum core and a first facing material and a second facing material sandwiching the gypsum core, wherein the gypsum core comprises gypsum and one or more chloride ion mitigating additives comprising a chelating agent, a mild acid-amine combination, sodium triphosphate, a bentonite clay, expanded vermiculite, expanded graphite, urea, ascorbic acid, an aluminoferrite, fly ash, a cryptand, a C—H bonding cage, metakaolin-lime paste, a mesoporous silica, a synthetic magnesium silicate, ground glass, foam glass, or a combination thereof, the one or more chloride ion mitigating additives reducing the chloride ion content of the gypsum panel by about 10% or more.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including one or more chloride ion mitigating additives as defined herein. In this regard, the gypsum core can include gypsum (i.e., calcium sulfate dihydrate), one or more chloride ion mitigating additives, and may include other optional additives. The present inventors have discovered that the gypsum panel disclosed herein can have various benefits due to the use of one or more chloride ion mitigating additives. For instance, the present inventors have discovered that the mechanical properties and characteristics of the panel may be improved. For instance, the gypsum panel disclosed herein can have increased nail pull resistance, increased panel strength, and enhanced bonding between the gypsum core and the respective facing materials.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In general, the gypsum core may comprise calcium sulfate dihydrate. The gypsum may be from a natural source or a synthetic source and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In addition, the gypsum core may comprise one or more chloride ion mitigating additives. In one embodiment, one or more chloride ion mitigating additives can mitigate chloride ions present in any and all components of the gypsum core. For instance, one or more chloride ion mitigating additives can mitigate chloride ions present in the water of the gypsum core. Further, for instance, one or more chloride ion mitigating additives can mitigate chloride ions present in the stucco of the gypsum core.

Generally, chloride ions migrate directionally from the gypsum core to the first facing material and or second facing material of a gypsum panel. Such directional migration generally occurs when the panel is supplied to a heating or drying device, such as a kiln. The inclusion of the one or more chloride ion mitigating additives in the gypsum panel disclosed herein may mitigate or prevent the migration of chloride ions such that a gypsum panel formed in accordance with the present disclosure has increased nail pull resistance, increased panel strength, and enhanced bonding between the gypsum core and the facing materials.

Notably, the one or more chloride ion mitigating additives of the present disclosure may pacify chloride ions through chemical and/or physical ion binding. For instance, one or more chloride ion mitigating additives may form a chemical bond with the chloride ion such that the chloride ion is pacified through chemical ion binding. Further, for instance, the chloride ion may be physically adsorbed by the one or more chloride ion mitigating additives such that the chloride ion is pacified through physical ion binding.

As used herein, “mitigating additive” refers to an additive that pacifies an atom or molecule such that the atom or molecule is unable to materially affect the mechanical properties and characteristics of a gypsum panel. Notably, chloride ions may affect the mechanical properties and characteristics of a gypsum panel. Chloride ions are hygroscopic and strongly adhere to water molecules through hydrogen bonds. This strong adherence to water molecules may result in the gypsum panel having decreased nail-pull resistance, decreased panel strength, decreased facing material-gypsum core bond strength, inadequate drying of the gypsum core, and increased calcination.

Additionally, the mitigating additive of the present disclosure may pacify other ions that may be present in the gypsum panel such as fluorine and/or bromine.

As indicated herein, in one embodiment, the gypsum core may comprise one or more chloride ion mitigating additives. For instance, the gypsum core may include volcanic rock, amorphous volcanic glass, pyrolyzed biomass, a silicate, or mixtures thereof.

In one embodiment, one or more chloride ion mitigating additives may comprise volcanic rock. For instance, the volcanic rock can comprise pumice, such as mine grade pumice or micronized pumice. The pumice may be derived from high silica content lavas, intermediate silica content lavas, or low silica content lavas. Generally, the color of the pumice is indicative of the silica content of the pumice. For instance, the pumice may be derived from white rock, which generally has high silica content, yellow or brown rock, which generally has intermediate silica content, or black rock, which generally has low silica content. In one embodiment, one or more chloride ion mitigating additives may contain a combination of different silica content pumices. Further, in another embodiment, the pumice or combination of pumices may be optimized for chloride ion mitigation, such that the nail pull resistance and gypsum panel strength are enhanced while also selectively choosing the various amounts of aluminum, iron, potassium, calcium, and magnesium stemming from the pumice or combination of pumices in the gypsum panel.

The pumice may have an average particle size of about 10 microns to about 2500 microns, such as about 10 microns or more, such as about 25 microns or more, such as about 50 microns or more, such as about 75 microns or more, such as about 100 microns or more, such as about 125 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more. Generally, the average particle size of the pumice may be about 2500 microns or less, such as about 1500 microns or less, such as about 1300 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 150 microns or less, such as about 125 microns or less, such as about 100 microns or less, such as about 75 microns or less, such as about 50 microns or less, such as about 25 microns or less. Furthermore, in one aspect, the aforementioned values may refer to a median particle size of the pumice.

The pumice may have a bulk density from about 100 kg/m³ to about 1300 kg/m³, such as about 100 kg/m³ or more, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 750 kg/m³ or more, such as about 800 kg/m³ or more, such as about 850 kg/m³ or more, such as about 900 kg/m³ or more, such as about 1000 kg/m³ or more, such as about 1100 kg/m³ or more. Generally, the pumice has a bulk density of less than about 1300 kg/m³, such as about 1200 kg/m³ or less, such as about 1100 kg/m³ or less, such as about 1000 kg/m³ or less, such as about 900 kg/m³ or less, such as about 850 kg/m³ or less, such as about 800 kg/m³ or less, such as about 750 kg/m³ or less, such as about 700 kg/m³ or less, such as about 600 kg/m³ or less, such as about 500 kg/m³ or less, such as about 400 kg/m³ or less, such as about 300 kg/m³ or less, such as about 200 kg/m³ or less.

In another embodiment, one or more chloride ion mitigating additives may comprise an amorphous volcanic glass. In one embodiment, the amorphous volcanic glass may comprise perlite. The perlite may be unexpanded perlite, expanded perlite, or a combination thereof. The unexpanded perlite may have a bulk density from about 900 kg/m³ to about 1300 kg/m³, such as about 900 kg/m³ or more, such as about 950 kg/m³ or more, such as about 1000 kg/m³ or more, such as about 1050 kg/m³ or more, such as about 1060 kg/m³ or more, such as about 1070 kg/m³ or more, such as about 1080 kg/m³ or more, such as about 1090 kg/m³ or more, such as about 1100 kg/m³ or more, such as about 1120 kg/m³ or more. Generally, the unexpanded perlite has a bulk density of about 1300 kg/m³ or less, such as about 1200 kg/m³ or less, such as about 1180 kg/m³ or less, such as about 1160 kg/m³ or less, such as about 1140 kg/m³ or less, such as about 1120 kg/m³ or less, such as about 1100 kg/m³ or less, such as about 1080 kg/m³ or less, such as about 1060 kg/m³ or less, such as about 1040 kg/m³ or less, such as about 1020 kg/m³ or less.

In yet another embodiment, one or more chloride ion mitigating additives may comprise a silicate. The silicate mineral may be in the form of coarse granulated particles and/or fine granulated particles. In one aspect, the silicate mineral may be in the form of a powder. The silicate mineral may be any one of a nesosilicate, sorosilicate, cyclosilicate, inosilicate (single chain), inosilicate (double chain), phyllosilicate, or tectosilicate. For instance, in one aspect, the silicate may comprise a phyllosilicate, such as an attapulgite clay. The attapulgite clay may be a composite of smectite and palygorskite. The attapulgite clay may be in the form of a powder or coarse granules. In one embodiment, the silicate may comprise attapulgite clay and an aluminosilicate, such as a hydrated magnesium aluminosilicate. In one embodiment, the one or more chloride ion mitigating additives may comprise Attagel®. In this respect, the one or more chloride ion mitigating additives may comprise Attagel® 15, Attagel® 30, Attagel® 40, Attagel® 50, or Attagel® 350.

Generally, the attapulgite clay may have a bulk density from about 100 kg/m³ to about 1200 kg/m³, such as about 100 kg/m³ or more, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more, such as about 900 kg/m³ or more, such as about 1000 kg/m³ or more. The attapulgite clay may have a bulk density of about 1200 kg/m³ or less, such as about 1100 kg/m³ or less, such as about 1000 kg/m³ or less, such as about 900 kg/m³ or less, such as about 800 kg/m³ or less, such as about 700 kg/m³ or less, such as about 600 kg/m³ or less, such as about 500 kg/m³ or less, such as about 400 kg/m³ or less, such as about 300 kg/m³ or less, such as about 200 kg/m³ or less.

As previously disclosed, in one aspect, the one or more chloride ion mitigating additives may comprise an aluminosilicate, such as a hydrated aluminosilicate. A non-limiting list of aluminosilicates that may be utilized as one or more chloride ion mitigating additives may be zeolite, andalusite, kyanite, sillimanite, or a combination thereof. In one aspect, the zeolite may be a natural zeolite, a modified zeolite, a zeotype, or a combination thereof. For instance, the zeolite may be a microporous zeolite or a mesoporous zeolite.

In a further embodiment, one or more chloride ion mitigating additives may comprise pyrolyzed biomass. For instance, one or more chloride ion mitigating additives can comprise biochar. As used herein, “pyrolysis” is the heating of organic material in the absence of oxygen. The biochar of the gypsum panel may be processed such that it is optimized for chloride ion mitigation. For instance, the specific surface area or cation exchange capacity of the biochar may be improved such that the adsorption of chloride ions is enhanced. Indeed, chloride ions may be removed from or mitigated in the gypsum panel through the presence of cations on the biochar surface such as calcium, magnesium, and/or potassium. Further, the porosity of the biochar may be increased such that there is increased physical adsorption of chloride ions by the porous structure of the biochar.

In another aspect, the one or more chloride ion mitigating additives may comprise an aluminum phosphate. For instance, the one or more chloride ion mitigating additives may comprise augelite, berlinite, or a combination thereof.

In a further aspect, the one or more chloride ion mitigating additives may comprise diatomaceous earth. The diatomaceous earth may be granulated diatomaceous earth, milled diatomaceous earth, micronized diatomaceous earth, or calcined diatomaceous earth.

In yet another aspect, the one or more chloride ion mitigating additives may comprise a coordination polymer. The coordination polymer may be an inorganic polymer or organometallic polymer. The coordination polymer may be one-dimension, two-dimensional, or three-dimensional. In one aspect, the coordination polymer may be a metal organic framework.

In yet another further aspect, the one or more chloride ion mitigating additives may include laterite, bauxite, or a combination thereof.

In an additional aspect, the one or more chloride ion mitigating additives may include silica gel.

In one aspect, the one or more chloride ion mitigating additives may include one or more chloride ion mitigating additives in the form of a molecular sieve. For instance, the one or more chloride ion mitigating additives may include a microporous sieve, a mesoporous sieve, or a macroporous sieve. In this respect, one or more chloride ion mitigating additives may be in the form of microporous sieves, mesoporous sieves, or macroporous sieves.

In order to provide the desired effect, the one or more chloride ion mitigating additives may have a selectively chosen average particle size. It should be noted that the respective average particle sizes of the components (e.g., pumice) previously disclosed herein are non-limiting. For instance, the one or more chloride ion mitigating additives may have an average particle size of 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The one or more chloride ion mitigating additives may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more. Furthermore, in one aspect, the aforementioned values may refer to a median particle size of the one or more chloride ion mitigating additives.

The one or more chloride ion mitigating additives may have a selectively chosen particle size distribution. The particle size distribution of the one or more chloride ion mitigating additives may be monomodal, bi-modal, or multi-modal. The one or more modes may fall within any of the particle size values, including any ranges thereof, disclosed herein. In one aspect, a mesh size of 25 to 5600 microns may retain from about 0 wt. % to about 100 wt. % of the one or more chloride ion mitigating additives, including all increments of 0.01 wt. % therebetween.

The one or more chloride ion mitigating additives of the present disclosure may reduce the chloride ion content, as measured in ppm, of a gypsum panel by about 5% to about 95%, including all increments of 0.01% therebetween. A section of the gypsum panel, particularly the gypsum core, may be crushed and dissolved in water to measure the chloride content of the gypsum panel. The chloride content may be measured using an electrode, such as a Chloride Ion-Selective Electrode (ISE). The chloride-ion content may be referred to as the chloride content of a gypsum panel.

In one aspect, the one or more chloride ion mitigating additives may reduce the chloride ion content of a gypsum panel by about 1% or more, such as about 3% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more. The one or more chloride ion mitigating additives may reduce the chloride ion content of the gypsum panel by about 95% or less, such as about 90% or less, such as about 80% or less, such as about 70% or less, such as about 60% or less, such as about 50% or less, such as about 40% or less, such as about 30% or less, such as about 20% or less, such as about 10% or less. For instance, if a gypsum panel has a chloride content of about 226 ppm, the inclusion of the one or more chloride ion mitigating additives in the gypsum panel may reduce the chloride ion content by about 50%, resulting in a gypsum panel having a chloride ion content of about 113 ppm.

It should be understood that the gypsum core may include one or more chloride ion mitigating additives, such as one or more of any of the chloride ion mitigating additives mentioned above. Further, for instance, the gypsum core may include chloride ion mitigating additives such as a chelating agent, a mild acid-amine combination, boric acid, sodium triphosphate, a bentonite clay, expanded vermiculite, expanded graphite, urea, cellulose, sodium monofluorophosphate, Vitamin C (ascorbic acid), an aluminoferrite, fly ash, a cryptand (e.g., cryptand SC24, cryptand triazolo cage), a C—H bonding cage, metakaolin-lime paste, an activated alumina, a mesoporous silica (e.g., MCM-41, SBA-15), an activated carbon, a synthetic magnesium silicate, ground glass (e.g., recycled glass, recycled soda lime glass), foam glass (e.g., Poraver® glass), or a combination thereof.

Generally, one or more chloride ion mitigating additives may be present in any element of the disclosed gypsum panel. For instance, one or more chloride ion mitigating additives may be present in one or more of the facing materials of the gypsum panel. Additionally or alternatively, for instance, one or more chloride ion mitigating additives may be present in the gypsum slurry or the gypsum core of the gypsum panel. Further, for instance, one or more chloride ion mitigating additives may be present in one or more gypsum core layers (e.g., first gypsum core layer, second gypsum core layer, third gypsum core layer) of the gypsum panel.

The one or more chloride ion mitigating additives may be present in the gypsum panel in an amount of 0.001 lbs/MSF to 125 lbs/MSF, including all increments of 0.001 lbs/MSF therebetween. For instance, the one or more chloride ion mitigating additives may be present in the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more, such as 50 lbs/MSF or more, such as 75 lbs/MSF or more, such as 100 lbs/MSF or more. Generally, the one or more chloride ion mitigating additives may be present in the gypsum panel in an amount of 125 lbs/MSF or less, such as 100 lbs/MSF or less, such as 75 lbs/MSF or less, such as 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In general, one or more chloride ion mitigating additives may be present in a gypsum panel, including any component thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 10 wt. % or more. Generally, one or more chloride ion mitigating additives may be present in a gypsum panel, including any component thereof, in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes one or more chloride ion mitigating additives. In this regard, the method may include a step of also combining one or more chloride ion mitigating additives with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more. The gypsum slurry may have bubbles or voids having a median size of 1400 microns or less, such as 1300 microns or less, such as 1200 microns or less, such as 1100 microns or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

In one embodiment, the gypsum core may include a first gypsum core layer and a second gypsum core layer. The first gypsum core layer may be between the first facing material (i.e., front of the panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers may be a particularly suitable location for one or more chloride ion mitigating additives. When included in a gypsum core layer, a chloride ion mitigating additive may reduce the negative effects of chloride ions on the gypsum core layer such as inadequate drying of the gypsum core layer and increased calcination of the gypsum core layer. Further, when the gypsum panel includes a first gypsum core layer and a second gypsum core layer, chloride ions may migrate directionally to the interface of the first gypsum core layer and the first facing material and may migrate directionally to the interface of the second gypsum core layer and the second facing material. In one aspect, having an amount of one or more chloride ion mitigating additives present in the first gypsum core layer may have enhanced efficacy in mitigating chloride ions when compared to having a similar amount of one or more chloride ion mitigating additives present in the second gypsum core layer. Such enhanced efficacy may be a result of the concentration of the one or more chloride ion mitigating additives present in the first gypsum core layer, which may be more than the concentration of the one or more chloride ion mitigating additives present in the second gypsum core layer. In this respect, adding an amount of the one or more chloride ion mitigating additives in the first gypsum core layer may be more effective than adding the same amount of the one or more chloride ion mitigating additives in the second gypsum core layer.

In some aspects, as previously disclosed herein, the gypsum panel may include a first gypsum core layer, a second gypsum core layer, and a third gypsum core layer. In this respect, when the gypsum panel includes a first gypsum core layer, a second gypsum core layer, and a third gypsum core layer, chloride ions may migrate directionally to the interface of the first gypsum core layer and the first facing material and may migrate directionally to the interface of the third gypsum core layer and the second facing material. In one embodiment, having an amount of one or more chloride ion mitigating additives present in the first gypsum core layer and/or the third gypsum core layer may have enhanced efficacy in mitigating chloride ions when compared to having a similar amount of one or more chloride ion mitigating additives present in the second gypsum core layer. Such enhanced efficacy may be a result of the migration pattern of chloride ions, which may migrate directionally from the gypsum core to the first facing material and/or the second facing material. Such enhanced efficacy may be a result of the concentration of the one or more chloride ion mitigating additives present in the first gypsum core layer and/or the third gypsum core layer, which may be more than the concentration of the one or more chloride ion mitigating additives present in the second gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as one or more chloride ion mitigating additives. Further, the first gypsum core layer, the second gypsum core layer, and/or the third gypsum core layer may contain an additive in an amount as previously indicated herein.

As indicated herein, the gypsum core can include one or more chloride ion mitigating additives. In this regard, in one embodiment, the first gypsum core layer may include one or more of the chloride ion mitigating additives disclosed herein. In another embodiment, the second gypsum core layer may include one or more of the chloride ion mitigating additives as disclosed herein. In a further embodiment, the third gypsum core layer may include one or more of the chloride ion mitigating additives as disclosed herein. In an even further embodiment, the first gypsum core layer and the second gypsum core layer may include one or more of the chloride ion mitigating additives as disclosed herein. In another further embodiment, the first gypsum core layer, the second gypsum core layer, and the third gypsum core layer may include one or more of the chloride ion mitigating additives as disclosed herein. In yet another embodiment, the one or more chloride ion mitigating additives may be included adjacent to the first facing material and/or second facing material.

Regardless of the above, one or more chloride ion mitigating additives may be present in any combination of gypsum core layers. However, in one embodiment, it should be understood that one or two of the aforementioned gypsum core layers may not include a chloride ion mitigating additive. In one aspect, one or more gypsum core layers may comprise the same chloride ion mitigating additive. Further, in one aspect, one or more gypsum core layers may comprise different chloride ion mitigating additives. The different chloride ion mitigating additives of one or more gypsum core layers may be chosen such that it is advantageous to have a particular chloride ion mitigating additive in one gypsum core layer and a different chloride ion mitigating additive in another, different gypsum core layer.

The gypsum panel disclosed herein may have many applications. For instance, the gypsum panel may be used as a standalone panel in construction for the preparation of walls, ceilings, roofs, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 2000 microns, such as about 90 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 3000 microns or less, such as about 1500 microns or less, such as about 1300 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1c/o. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Test Methods

Chloride Content: The chloride content is the chloride ion content of a gypsum panel or gypsum patty measured in ppm. After the formation of a gypsum panel or gypsum patty, each including a different chloride ion mitigating additive, the gypsum panel or gypsum patty was dried at 109° F. Next, a section of each gypsum panel or gypsum patty was removed after the drying of the gypsum panel or gypsum patty. The removed section of the gypsum panel or gypsum patty weighed five grams. The section of the gypsum panel or gypsum patty was then crushed and dissolved in water to measure the chloride content of the gypsum panel or gypsum patty. The chloride content was measured using an electrode, such as a Chloride Ion-Selective Electrode (ISE).

Nail Pull: The nail pull is determined in accordance with ASTM C1396-17 and ASTM C473-19. For this test, the specimens are conditioned from 70° F. to 100° F., in particular 70° F., and 50%+/−2% relative humidity for at least 24 hours, positioned so they do not warp. The reported value is the average of five specimens.

Humidified Bond: A humidified bond analysis is performed utilizing 12″ by 12″ specimens of the gypsum panel. The specimens are placed on edge in a humidity chamber at 90° F. and 90% humidity with faces 2+/−¼ inches apart. As reported below, the exposure was for either 2 hours or 20 hours. The specimens should have a moisture meter reading of 25-50+ upon completion of the humidification. Immediately, the specimens were analyzed to determine the bond. First, score lines should be scribed across the full width of the sample at 4″ from one edge on the face and 4″ in from the opposite edge on the back wherein the score lines are parallel to one another and perpendicular to the direction of machine travel. Next, firmly hold the specimen on a bench top and while face up, break the core along a score line and leave the paper intact on the side to be evaluated. Holding each portion of the specimen in separate hands and having the exposed broken core in a line of vision, exert a pulling force on one half of the specimen while holding the other half in a steady position in order to peel or tear the paper away from the core. Continue the pulling force until the paper peels away from the core to the maximum extent possible. Repeat this pulling action for the companion portion of the specimen. Then, repeat both steps for the back of the specimen. Next, determine the bond failure area where the facing material is removed from the gypsum core, with 100% indicative of no paper to gypsum core bond and 0% indicative of no paper to core failure (i.e. full paper bond to the core). The percent coverage can be determined using various optical/visual analytical techniques.

### Example 1

Gypsum patties were made which included a chloride ion mitigating additive in the respective gypsum patties. A gypsum patty is formed by a process including mixing about fifty (50) grams of stucco with about 32.5 grams of water. The mixture is mixed for ten (10) seconds to form a gypsum patty. As observed in Table 1 and Table 2, various additives were investigated for their ability to mitigate chloride ions. The values below the respective chloride ion mitigating additives are in units of ppm or parts per million and are representative of the chloride content of the gypsum patty. The respective chloride ion mitigating additives were added to the respective gypsum patty in amounts of 0 wt. %, 0.25 wt. %, 0.5 wt. %, 1 wt. %, and 2.5 wt. % based on the weight of stucco in the gypsum patty. The control sample, which contains no chloride ion mitigating additives, was formed by the same process and materials as all of the gypsum patties containing a chloride ion mitigating additive. The control sample was found to have a chloride content of 226 ppm. The “#1 Pumice” indicates a pumice where a mesh size of 180 microns retains 94% to 100% of the pumice by weight, a mesh size of 250 microns retains 34 to 64% of the pumice by weight, a mesh size of 300 microns retains 22% to 34% of the pumice by weight, and a mesh size of 425 microns retains 0% to 0.05% of the pumice by weight. The “#1 ½ Pumice” indicates a pumice where a mesh size of 180 microns retains 92% to 100% of the pumice by weight, a mesh size of 250 microns retains 80 to 94% of the pumice by weight, a mesh size of 300 microns retains 54% to 84% of the pumice by weight, and a mesh size of 425 microns retains 0% to 0.05% of the pumice by weight. The “Unexpanded Perlite #72” indicates a perlite where a U.S. standard mesh No. 16 retains 0% to 10% of the perlite by weight, a U.S. standard mesh No. 20 retains 15% to 30% of the perlite by weight, a U.S. standard mesh No. 30 retains 40% to 60% of the perlite by weight, a U.S. standard mesh No. 50 retains 80% to 90% of the perlite by weight, and a U.S. standard mesh No. 100 retains 90% to 100% of the perlite by weight.

TABLE 1

| Chloride | | | | | | | |
|---|---|---|---|---|---|---|---|
| Ion | | | | | | | |
| Mitigating | | | | | | | |
| Additive | | | | | | | |
| Amount | Activated | Ascorbic | | Attapulgite | # 1 | # 1 1/2 | Sodium |
| [g] | Carbon | Acid | Biochar | Clay | Pumice | Pumice | Triphosphate |
| 0.0 | 226 | 226 | 226 | 226 | 226 | 226 | 226 |
| 0.25 | 266 | — | 101 | 134 | 109 | 98 | 139 |
| 0.5 | 198 | 270 | 120 | 124 | 173 | 142 | 211 |
| 1.0 | 218 | 199 | 206 | 204 | 154 | 125 | 199 |
| 2.5 | 295 | 206 | 424 | 149 | 135 | 110 | 163 |

TABLE 2

| Chloride | | | | | | | |
|---|---|---|---|---|---|---|---|
| Ion | | | | | | | |
| Mitigating | | | | | | | |
| Additive | | | | | | | |
| Amount | Bentonite | Boric | Expanded | Unexpanded | Expanded | | |
| [g] | C | Acid | Vermiculite | Perlite # 72 | Graphite | Urea | Cellulose |
| 0.0 | 226 | 226 | 226 | 226 | 226 | 226 | 226 |
| 0.25 | 223 | — | 177 | 128 | 188 | 189 | 235 |
| 0.5 | 147 | 172 | 131 | 132 | 295 | 216 | 117 |
| 1.0 | 128 | 168 | 119 | 156 | 202 | 213 | 159 |
| 2.5 | 129 | 226 | 175 | 131 | 147 | 168 | 221 |

### Example 2

Gypsum panels were made which included a chloride ion mitigating additive in the gypsum panels. Chloride ions were added to the gypsum slurry that formed the gypsum core of the gypsum panel in the form of sodium chloride in amounts of 0 ppm and 5000 ppm as illustrated in Table 3. As observed in Table 3, pumice was investigated for its ability to mitigate chloride ions. The pumice was added to the gypsum panel in amounts of 0 wt. %, 0.125 wt. %, and 0.25 wt. % based on the weight of stucco in the gypsum panel. The quantitative expression of humidified bond in Table 3 is in the format of the humidified bond of the facing material/the humidified bond of the backing material. For instance, when the quantitative expression of the humidified bond is 2/79, the humidified bond of the facing material is 2% and the humidified bond of the backing material is 79%. The “#⅛ Pumice” indicates a pumice where a mesh size of 75 microns retains 85% to 100% of the pumice by weight, a mesh size of 150 microns retains 70% to 90% of the pumice by weight, a mesh size of 300 microns retains 40% to 75% of the pumice by weight, and a mesh size of 600 microns retains 20% to 60% of the pumice by weight. The “#1 ½ Pumice” indicates a pumice where a mesh size of 180 microns retains 92% to 100% of the pumice by weight, a mesh size of 250 microns retains 80% to 94% of the pumice by weight, a mesh size of 300 microns retains 54% to 84% of the pumice by weight, and a mesh size of 425 microns retains 0% to 0.05% of the pumice by weight.

TABLE 3

| Chloride Ions | | | | |
|---|---|---|---|---|
| Added to | | Humidified | Board | Nail Pull |
| Gypsum Panel | Pumice | Bond | Weight | Resistance |
| [ppm] | [%] | [%] | [lbs/MSF] | [lb_{f}] |
| 0 | 0 | 1/1 | 1288 | 78 |
| 5000 | 0 | 2/79 | 1261 | 56 |
| 5000 | 0.125 | 1/5 | 1239 | 63 |
| | (# 1½ Pumice) | | | |
| 5000 | 0.25 | 1/7 | 1267 | 60 |
| | (# 1½ Pumice) | | | |
| 5000 | 0.125 | 8/10 | 1228 | 68 |
| | (# ⅛ Pumice) | | | |
| 5000 | 0.25 | 1/2 | 1243 | 66 |
| | (# ⅛ Pumice) | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising a gypsum core and a first facing material and a second facing material sandwiching the gypsum core, wherein the gypsum core comprises gypsum and one or more chloride ion mitigating additives comprising volcanic rock, amorphous volcanic glass, pyrolyzed biomass, a silicate, or a combination thereof, the one or more chloride ion mitigating additives reducing the chloride ion content of the gypsum panel by about 10% or more.

2. The gypsum panel of claim 1, wherein the volcanic rock comprises pumice.

3. The gypsum panel of claim 2, wherein the pumice has an average particle size from about 50 microns to about 600 microns.

4. The gypsum panel of claim 1, wherein the amorphous volcanic glass comprises perlite.

5. The gypsum panel of claim 4, wherein the perlite is unexpanded perlite.

6. The gypsum panel of claim 1, wherein the gypsum core comprises a silicate.

7. The gypsum panel of claim 6, wherein the silicate comprises an attapulgite clay.

8. The gypsum panel of claim 1, wherein the pyrolyzed biomass comprises biochar.

9. The gypsum panel of claim 1, wherein the one or more chloride ion mitigating additives pacify the chloride ions of the gypsum core physically.

10. The gypsum panel of claim 1, wherein the one or more chloride ion mitigating additives pacify the chloride ions of the gypsum core chemically.

11. The gypsum panel of claim 1, wherein the one or more chloride ion mitigating additives pacify the chloride ions of the gypsum core physically and chemically.

12. The gypsum panel of claim 1, wherein the one or more chloride ion mitigating additives are present in the gypsum panel in an amount from 0.2 lbs/MSF to 125 lbs/MSF.

13. The gypsum panel of claim 1, wherein the one or more chloride ion mitigating additives are present in the gypsum panel in an amount from 0.2 lbs/MSF to 50 lbs/MSF.

14. The gypsum panel of claim 1, wherein the one or more chloride ion mitigating additives are present in the gypsum panel in an amount from 0.5 lbs/MSF to 2.5 lbs/MSF.

15. The gypsum panel of claim 1, wherein the one or more chloride ion mitigating additives are present in the gypsum core in an amount from 0.05 wt. % to 20 wt. % based on the weight of gypsum in the gypsum core.

16. The gypsum panel of claim 1, wherein the one or more chloride ion mitigating additives are present in the gypsum core in an amount from 0.05 wt. % to 10 wt. % based on the weight of gypsum in the gypsum core.

17. The gypsum panel of claim 1, wherein the one or more chloride ion mitigating additives are present in the gypsum core in an amount from 0.05 wt. % to 5 wt. % based on the weight of gypsum in the gypsum core.

18. The gypsum panel of claim 1, wherein the gypsum core comprises a first gypsum core layer and a second gypsum core layer, the first gypsum core layer between the second gypsum core layer and the first facing material and having a density greater than the second gypsum core layer, the one or more chloride ion mitigating additives being present in the second gypsum core layer.

19. The gypsum panel of claim 18, wherein the one or more chloride ion mitigating additives are also present in the first gypsum core layer.

20. The gypsum panel of claim 19, wherein the first gypsum core layer and the second gypsum core layer comprise different chloride ion mitigating additives.

21. The gypsum panel of claim 18, wherein the one or more chloride ion mitigating additives are present in the second gypsum core layer in an amount from 0.05 wt. % to 20 wt. % based on the weight of gypsum in the second gypsum core layer.

22. The gypsum panel of claim 18, wherein the one or more chloride ion mitigating additives are only present in only one layer of the gypsum core.

23. A method for making the gypsum panel of claim 1 comprising:
providing a first facing material;
depositing a gypsum slurry comprising stucco, water, and one or more chloride ion mitigating additives onto the first facing material, wherein the one or more chloride ion mitigating additives comprise volcanic rock, amorphous volcanic glass, pyrolyzed biomass, a silicate, or a combination thereof, the one or more chloride ion mitigating additives reducing the chloride ion content of the gypsum panel by about 10% or more;
providing a second facing material on the gypsum slurry; and
allowing the stucco to convert to calcium sulfate dihydrate.

25. A gypsum panel comprising a gypsum core and a first facing material and a second facing material sandwiching the gypsum core, wherein the gypsum core comprises gypsum and one or more chloride ion mitigating additives comprising a chelating agent, a mild acid-amine combination, sodium triphosphate, a bentonite clay, expanded vermiculite, expanded graphite, urea, ascorbic acid, an aluminoferrite, fly ash, a cryptand, a C—H bonding cage, metakaolin-lime paste, a mesoporous silica, a synthetic magnesium silicate, ground glass, foam glass, or a combination thereof, the one or more chloride ion mitigating additives reducing the chloride ion content of the gypsum panel by about 10% or more.
